(19) United States
(12) Patent Application Publication
(10) Pub. No.: US 2012/0063493 A1
(43) Pub. Date: Mar. 15, 2012

(54) TRANSMISSION RATE CONTROL METHOD, TRANSMISSION UNIT, AND COMMUNICATION SYSTEM

(76) Inventors: Yohei Hasegawa, Tokyo (JP); Takayuki Jibiki, Tokyo (JP); Yasuhiro Mizukoshi, Tokyo (JP)

(21) Appl. No.: 13/203,741

(22) PCT Filed: Feb. 16, 2010
(86) PCT No.: PCT/JP2010/000950

§ 371 Date: Dec. 6, 2011

(30) Foreign Application Priority Data
Mar. 6, 2009 (JP) 2009-054004

(51) Int. Cl. H04L 25/03; H04B 17/02

(52) U.S. Cl. 375/211; 375/296

(57) ABSTRACT

A transmission unit includes: transmission rate control means for controlling a transmission rate; first transmission error detecting means for detecting data loss caused due to congestion in a transmission network; and second transmission error detecting means for detecting data loss (for example, packet loss) caused due to data error in the communication network. In the transmission unit, the transmission rate control means controls the transmission rate separately for a case where the first transmission error detecting means has detected data loss and a case where the second transmission error detecting means has detected data loss caused due to data error.

### TECHNICAL FIELD

The present invention relates to a transmission rate control method, a transmission unit, and a communication system each for determining a transmission rate of communication.

### BACKGROUND ART

In TCP/IP (Transport Control Protocol/Internet Protocol) communication used on the Internet, communication is performed while each transmission unit determines a transmission rate depending on line speeds and congestion levels of lines. For TCP Reno, which is the most commonly used TCP, once communication is initiated, a transmitting side gradually increases a transmission rate until packet loss occurs.

Generally, the transmitting side increases a transmission rate in proportion to round-trip time of a packet. That is, the transmitting side increases the transmission rate by one packet every time a packet makes a round trip between the transmitting side and a receiving side. When packet loss occurs in a network, the transmitting side observes an acknowledgement (ACK packet) from the receiving side so that the transmitting side can be notified that the packet loss occurs. When the packet loss occurs, the transmitting side controls the transmission rate to be halved.

A high transmission rate in communication using TCP requires no occurrence of packet loss for sufficiently long time with respect to RTT (Round Trip Time). For example, in a case of a line which RTT is 100 ms, in order to increase a throughput to 10 Gbps in communication using TCP, it is necessary that no packet is lost for about two hours. However, it is difficult in most cases to achieve such a low packet loss rate, actually.

In view of this, various attempts of improving TCP and networks are being made to achieve a high throughput in the communication using TCP even in a case where packet loss occurs.

An example of the improved TCP is TCP Westwood. In the TCP Westwood, when packet loss occurs, it is determined whether or not a round-trip delay time (RTT) in a network is increased to more than a normal round-trip delay time. If the RTT does not increase to more than the normal round-trip delay time, it is determined that a transmission error occurs in a link, so that a transmission rate is not decreased (see Non Patent Literature (NPL) 1, for example).

However, in a high-speed line, a buffer in a network unit becomes full in a short period of time, which changes RTT fast. Such a fast change of RTT makes it difficult to detect an increase in RTT. Further, in long-distance communication, since the communication is established via many network units, RTT is constantly changed. This makes it difficult to accurately detect an increase in delay at a bottleneck portion. Thus, even with the use of the improved TCP, a high performance cannot be achieved.

In the meantime, Patent Literature (PTL) 1 proposes such a method that gateway units are placed so as to sandwich a wireless area so that a network status can be accurately grasped, a transmission error occurring in the wireless area is measured, and a level of error resistance of a forward error correction code (FEC) is set based on the transmission error thus measured. The method proposed in PTL 1, however, does not perform a transmission rate control method for TCP. With the use of the method proposed in PTL 1, it is possible to camouflage packet loss caused due to bit error in the wireless area. However, the above-described problem of packet loss that occurs in the long-distance communication performed at high speed still cannot be solved.

PTL 2 proposes a unit for preventing packets from being lost when an error rate increases in a wireless link. The unit proposed in PTL 2 observes error in the wireless link. When a rate of errors increases, the unit stops a TCP communication between terminals. In order to stop the TCP communication, the unit transmits a packet by changing, to 0, an advertised window (indicating a data size receivable by a receiver) described in an acknowledgement in TCP. However, in this method, no packet can be transmitted while the error rate in the wireless link is increasing. Further, a value once advertised by an advertised window exchanged between the terminals cannot be decreased. This makes it difficult to fully stop the communication immediately. This causes such a disadvantage that packet loss occurs eventually.

### CITATION LIST

### Patent Literature

PTL 1: Japanese Patent Application Publication, Tokukai, No. 2003-152752 A

PTL 2: Japanese Patent No. 3797538 B

### Non Patent Literature

NPL 1: S. Mascolo, C. Casetti, M. Gerla, S. S. Lee, and M. Sanadidi, “TCP Westwood: congestion control with faster recovery”, UCLA CSD Technical Report #200017, 2000

### SUMMARY OF INVENTION

### Technical Problem

As described above, in a case where a high-speed long-distance line is used, communication performance of a terminal-to-terminal transmission protocol is not exercised. Here, the communication performance encompasses transmission rate control for TCP, SCTP (Stream Control Transmission Protocol), or the like. More specifically, since any reason for causing packet loss or an increase in delay is not found out, a transmission rate for communication using TCP cannot be set appropriately. Further, in a high-speed communication, since a terminal cannot detect a sign of packet loss, the terminal cannot set a transmission rate for TCP as appropriate, thereby resulting in that packet loss occurs. Furthermore, in the TCP communication, in a case where RTT is large, it takes long to set a suitable transmission rate.

In view of this, the present invention is aimed at providing a transmission rate control method, a transmission unit, and a communication system, each of which can perform a suitable transmission rate control in accordance with a congestion state in such a manner that whether data loss occurs or not is determined and information on transmission error is collected from a communication unit in a network, and data loss caused by factors other than congestion is found out by referring to a determination result and a collection result so as to appropriately find out what causes the data loss and what causes an increase in delay.

### Solution to Problem

A transmission rate control method according to the present invention is a transmission rate control method for controlling a transmission rate by a transmission unit that transmits data to a reception unit via a communication network, and the transmission rate control method according to the present invention includes: detecting that data loss occurs due to congestion in the communication network; detecting that data loss has occurred due to data error in the communication network; and applying different transmission rate controls, respectively, to a case where data loss is caused due to congestion and to a case where data loss is caused due to data error.

A transmission unit according to the present invention is a transmission unit for transmitting data to a reception unit via a communication network, and the transmission unit according to the present invention includes: transmission rate control means for controlling a transmission rate; first transmission error detecting means for detecting data loss caused due to congestion in the communication network; and second transmission error detecting means for detecting data loss caused due to data error in the communication network, the transmission rate control means controlling the transmission rate separately for a case where the first transmission error detecting means has detected data loss and a case where the second transmission error detecting means has detected data loss caused due to data error.

A communication system according to the present invention is a communication system in which a transmission unit transmits data to a reception unit via a relay unit and a communication network, and the transmission unit in the communication system includes transmission rate control means for controlling a transmission rate; first transmission error detecting means for detecting data loss caused due to congestion in the communication network; and second transmission error detecting means for detecting data loss caused due to data error in the communication network, the transmission rate control means controlling the transmission rate separately for a case where the first transmission error detecting means has detected data loss and a case where the second transmission error detecting means has detected data loss caused due to data error.

### Advantageous Effects of Invention

In accordance with the present invention, it is possible to figure out appropriately what causes data loss and what caused an increase in delay, thereby making it possible to perform a suitable transmission rate control in accordance with a congestion state.

### BRIEF DESCRIPTION OF DRAWINGS

FIG. 1 is a block diagram showing Exemplary Embodiment 1 of a communication system according to the present invention.

FIG. 2 is a block diagram showing an example of an arrangement of a transmitter.

FIG. 3 is a flowchart showing an operation of a TCP processing section.

FIG. 4 is a flowchart showing an operation of the TCP processing section at the time of receiving an ACK.

FIG. 5 is block diagram showing an example of an arrangement of a switch.

FIG. 6 is a block diagram showing an example of an arrangement of line terminating equipment.

FIG. 7 is a block diagram showing Exemplary Embodiment 2 of the communication system according to the present invention.

FIG. 8 is a flowchart showing an operation of a TCP processing section according to Exemplary Embodiment 2 at the time of receiving an ACK.

FIG. 9 is a block diagram showing an essential part of the present invention.

### DESCRIPTION OF EMBODIMENTS

### Exemplary Embodiment 1

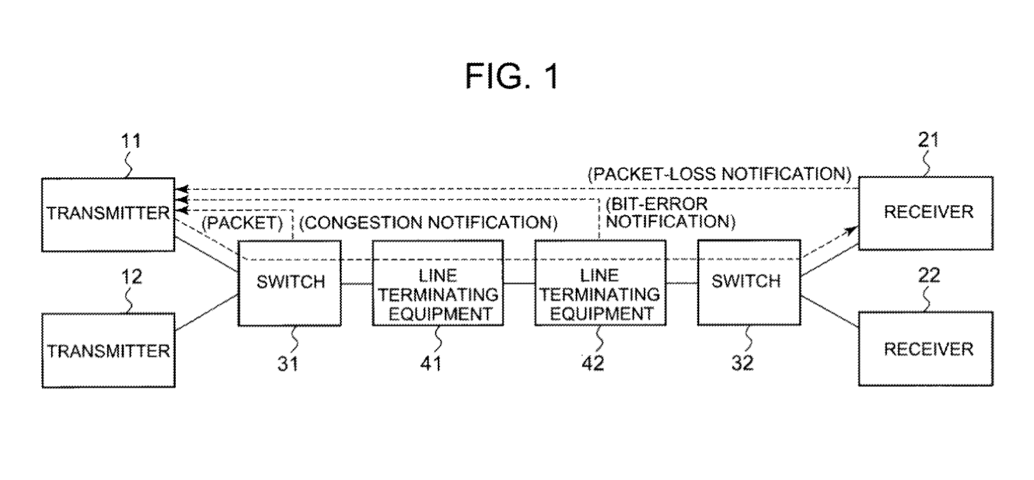

FIG. 1 is a block diagram showing Exemplary Embodiment 1 of a communication system according to the present invention.

The following explanation in the present exemplary embodiment takes, as an exemplary transmission protocol, TCP, which is most commonly used among terminal-to-terminal protocols including transmission rate control. TCP or the like protocol uses a value called a congestion window to control a transmission rate. The congestion window indicates the number of packets that a transmitter can transmit at a time in a network (communication network). The transmitter can transmit packets from a packet number of which an acknowledgement (ACK) is returned from a receiver, up to a packet number obtained by adding the number of packets indicated by the congestion window to the packet number of which the acknowledgement is returned. That is, the congestion window indicates the number of packets that the transmitter transmits in the network per time (RTT) when a packet makes a round trip in the network between the transmitter and the receiver. On this account, a transmission rate between the terminals is “congestion window/RTT”. In the present exemplary embodiment, the transmission rate is expressed mainly by use of the congestion window. However, the present exemplary embodiment can be also applied to other cases in which the transmission rate is expressed in other ways (for example, bps).

In the communication system shown in FIG. 1, it is assumed that a transmitter 11, which serves as a transmission unit, transmits data to a receiver 21 by use of TCP. The transmitter 11 transmits to a switch (first switch) 31 a packet group destined to the receiver 21. Packets are transferred to the switch 31, line terminating equipment (first line terminating equipment) 41, line terminating equipment (second line terminating equipment) 42, and a switch (second switch) 32, sequentially in this order. The packet group thus transferred is ultimately received by the receiver 21. At the same time, a transmitter 12 transmits a packet group to a receiver 22.

The packet group from the transmitter 11 and the packet group from the transmitter 12 flow into a single line via the switch 31. Therefore, two kinds of traffic, i.e., the packet group from the transmitter 11 and the packet group from the transmitter 12, cause congestion at the switch 31, thereby possibly causing packet loss. Further, in a communication network between the line terminating equipment 41 and the line terminating equipment 42, bit error may occur due to signal degradation or the like during transmission, thereby possibly causing packet loss.

In the present exemplary embodiment, in a case where the switch 31 receives packets from the transmitter 11 and determines that packet loss may occur due to congestion if it receives more packets, the switch 31 transmits a congestion notification to the transmitter 11. If a given packet is actually lost, the congestion notification may contain a serial number of the given packet. More specifically, in a case where a buffer of the switch 31 is full and cannot store any further packet therein, for example, when the switch 31 receives a packet via a communication line, the switch 31 refers to a packet header in the packet and transmits a congestion notification to a source of the packet.

Further, instead of the above arrangement in which the congestion notification is transmitted when the buffer cannot store any further packet because it is full, the congestion notification may be transmitted in advance when an occupancy rate of the buffer exceeds a setting value (for example, 90%). Further, such an arrangement is also possible that a fluctuation velocity at which the capacity of the buffer increases or decreases is estimated from communication history, and the congestion notification may be transmitted when the occupancy rate of the buffer increases and it is determined that the buffer may be full after a predetermined time.

Assume a case where the capacity of the buffer is Q Mbytes and an average increasing rate of the buffer is Q/10 per second (unit time) from communication history. Where the lowest rate of the occupancy rate of the buffer per unit time is expressed as “H” and the highest rate of the occupancy rate of the buffer per unit time is expressed as “S”, for example, the average increasing rate is calculated by use of a value (for example, H−S) obtained by comparing the lowest rate H and the highest rate S. A presumable example is such that in a case where the average increasing rate is Q/10, the congestion notification may be transmitted when an available capacity of the buffer is “9 Q/10”. Note that it is possible to determine the unit time to be used for the calculation of the average increasing rate based on a time T it takes for the congestion notification transmitted from the switch 31 to reach the transmitter 11.

Upon receiving the congestion notification from the switch 31, the transmitter 11 assumes that congestion has occurred, and adjusts a transmission rate for TCP. For example, the transmitter 11 decreases the transmission rate at a predetermined rate, such as ⅔ or the like. By controlling the transmission rate as such, it is possible to prevent an occurrence of packet loss in advance.

The above explanation takes, as an example, a case where congestion occurs at the time the switch 31 receives packets from the transmitter 11. However, the transmission rate is also controlled in the same manner even in a case where congestion occurs when the switch 31 receives packets from the transmitter 12.

As a well-known TCP communication technique, there is an ECN (Explicit Congestion Notification) technique in which a flag indicative of congestion at a router is described in a packet. However, in the ECN technique, an ECN flag is just set in a packet. Therefore, the transmitter can be notified, by the ECN flag, of the congestion only after the receiver has recognized the ECN flag described in a received packet and transmitted a packet to the transmitter, and then the packet thus transmitted has reached the transmitter. That is, it takes time corresponding to a round trip time of the packet until the transmitter receives the ECN flag. In this case, packet loss may occur due to congestion before the transmitter detects the congestion. Further, the ECN technique can be used when a sign of congestion can be detected. However, the ECN technique cannot be used when packet loss occurs due to bit error.

Further, in the present exemplary embodiment, instead of the congestion notification from the switch, a pause-signal function (or a back-pressure function or the like) defined by a link protocol may be used in order that the transmitter can recognize an occurrence of congestion. The pause-signal function is a function of transmitting a signal (a pause signal or a back-pressure signal) for temporarily stopping transmission of packets, to a transmitter (a switch or a terminal) that transmits packets to a communication line, in a case where congestion occurs at a switch provided at a destination end of the communication line. Note that the pause-signal function is a protocol of a link layer, and therefore a TCP processing section of a general transmitter cannot observe the pause signal. In view of this, in a case where the occurrence of congestion is recognized by use of the pause-signal function, the transmitter according to the present exemplary embodiment is so arranged as to receive a pause signal and convert the pause signal to a congestion notification in the transmitter. Further, instead of directly observing the pause signal, the TCP processing section of the transmitter can observe a transmission queue of an IP layer so as to determine an occurrence of congestion when the number of transmission queues of the IP layer increases.

The line terminating equipment 42 receives packets from the transmitter 11 via the line terminating equipment 41. In a case where a packet contains a bit error and therefore the packet is to be discarded, the line terminating equipment 42 transmits a bit-error notification to the transmitter 11 and the line terminating equipment 41. The bit-error notification to be transmitted to the transmitter 11 includes a serial number and the like of the packet thus discarded. Thus, the transmitter 11 can be notified of which packet has been lost. When the transmitter 11 receives the bit-error notification from the line terminating equipment 42, the transmitter 11 does not decrease a transmission rate of packets.

Upon receiving the bit-error notification from the line terminating equipment 42, the transmitter 11 immediately retransmits the packet that has been discarded. That is, regardless of a congestion state of the network, the transmitter 11 retransmits the packet. Further, even in a case where the transmitter 11 receives a packet indicative of an occurrence of packet loss from the receiver 21, the transmitter 11 determines that the packet loss is not caused by congestion, and does not decrease the transmission rate of packets.

Note that the transmitter 11 can increase the transmission rate more quickly than a transmission rate control by general TCP, even a case where the transmitter 11 does not receive a bit-error notification or a congestion notification. For example, in TCP Reno, after packet loss has occurred, the transmission rate is increased by one packet per RTT. In contrast, in the present exemplary embodiment, the transmitter 11 increases the transmission rate at a times as much speed as the current speed, or doubles the transmission rate per RTT, per any given time based on RTT (e.g., RTT/2), or per setting time. Alternatively, the transmitter 11 may be arranged so as to increase the transmission rate not based on RTT, but at a rate of “R/K” so that the transmission rate reaches a desired transmission rate R after a setting time K passes.

Moreover, the transmitter 11 may be arranged such that in a case where the transmitter 11 does not receive a bit-error notification or a congestion notification, the transmitter 11 cannot easily decrease the transmission rate even when packet loss has occurred, as compared to the transmission rate control by the general TCP (for example, TCP Reno). For example, in the general TCP, every time packet loss occurs, a congestion window is halved so as to halve the transmission rate. In contrast, in the present exemplary embodiment, the transmitter 11 may be arranged so as to decrease the transmission rate at a preset rate so that the transmission rate is stabilized. For example, the transmission rate may be decreased to 80% of a transmission rate at which packet loss occurred. Further, the transmitter 11 may be arranged, for example, so as to store histories of the transmission rate at which stable communication could be performed without packet loss and to determine the transmission rate by referring to the histories.

Further, the pieces of line terminating equipment 41 and 42, and the switches 31 and 32 may be arranged such that when they receive a packet from the transmitter 11, they notify the transmitter 11 of available line capacity or the like of a link in a transfer direction of the packet. For example, a maximum value of an available bandwidth in the switches 31 and 32 is line capacity. However, an expected throughput is a value obtained by splitting the line capacity into TCP connections. Further, a maximum bandwidth available in the pieces of line terminating equipment 41 and 42 is a value obtained by deducting, from the line capacity, an overhead caused by addition of an error-correction code. Note that in a case where no error-correction code is used between the pieces of line terminating equipment 41 and 42, an actually-available bandwidth (equivalent bandwidth) is a value (B(1−ρ)), which is obtained by multiplying the line capacity B by (1−p) where ρ indicates an error rate in a line. In this case, the transmitter 11 is notified of the available line capacity, etc., so that the transmitter 11 is indirectly notified of the error rate ρ.

Further, the transmitter 11 may adjust the transmission rate for TCP to the equivalent bandwidth. That is, the transmitter 11 may make the transmission rate fit in that maximum value of the transmission rate which is calculated based on the error rate. For example, the congestion window of TCP is set to (B(1−ρ)/RTT). Moreover, the equivalent bandwidth may be split into a plurality of TCP connections, for example. In other words, the transmitter 11 may control the congestion window so that a transmission rate for TCP for each of the plurality of TCP connections is (B(1−ρ)/C). Here, C indicates the number of TCP connections. In this case, a congestion window of each of the TCP connections is (B(1−ρ)/(C·(RTT)). Thus, the transmitter 11 changes the transmission rate in accordance with an occurrence state of data error.

The aforementioned explanation takes, as an example, a case where the transmitter 11 transmits packets. However, the same control as above is also performed in a case where the transmitter 12 transmits packets.

As described above, the transmitters 11 and 12 of the present exemplary embodiment can immediately read a sign of an occurrence of congestion in a network and recognize an occurrence of packet loss due to bit error. This allows the transmitters 11 and 12 to exercise their high communication performance.

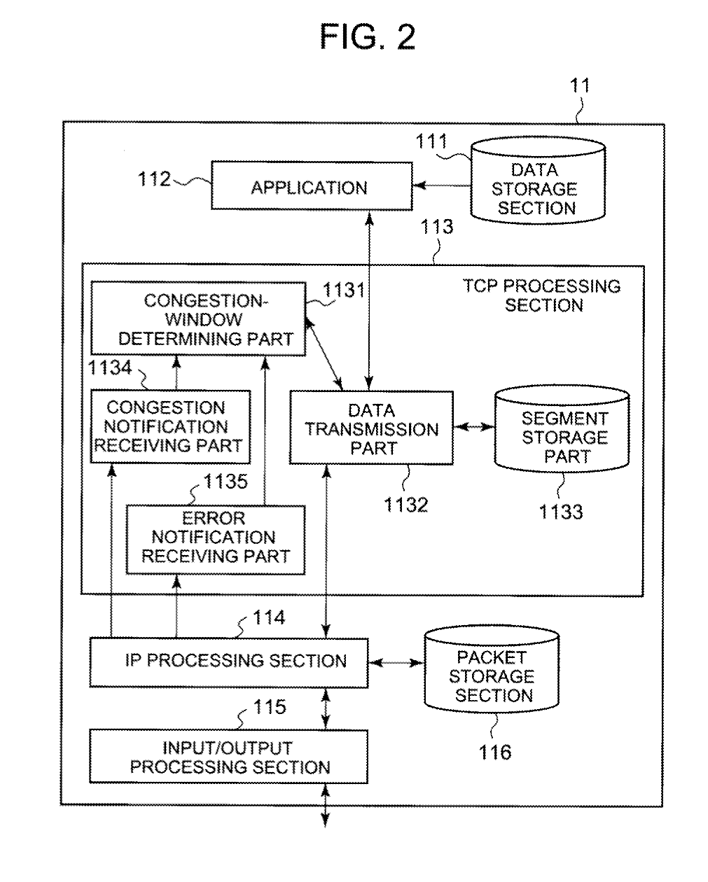

Next will be described a detailed example of an arrangement of the transmitters 11 and 12. FIG. 2 is a block diagram showing an example of the arrangement of the transmitter 11. The arrangement of the transmitter 12 is the same as that of the transmitter 11.

As shown in FIG. 2, the transmitter 11 includes: a data storage section 111 in which to store data to be transmitted; an application 112 for reading out data from the data storage section 111 and outputting the data to a TCP processing section 113; the TCP processing section 113 for segmenting the data received from the application 112 and outputting the data to an IP processing section 114 while controlling a transmission rate by referring to a congestion notification and an error notification; the IP processing section 114 for receiving packets from the TCP processing section 113 and outputting the packets to an input/output processing section 115; the input/output processing section 115 for transmitting the packets received from the IP processing section 114 to a communication line; and a packet storage section 116 in which the IP processing section temporarily stores the packets.

The TCP processing section 113 includes: a data transmission part 1132 for dividing the data received from the application 112 into segments, determining transmission of the data by referring to a congestion window, dividing the segments into packets, and supplying the packets to the IP processing section 114; a segment storage part 1133 in which to store information of the congestion window and the like, which are to be used by the data transmission part 1132 to perform segment processing; a congestion notification receiving part 1134 for sending a congestion notification received from the switch 31 to a congestion-window determining part 1131; and an error notification receiving part 1135 for sending an error notification received from the line terminating equipment 42 to the congestion-window determining part 1131.

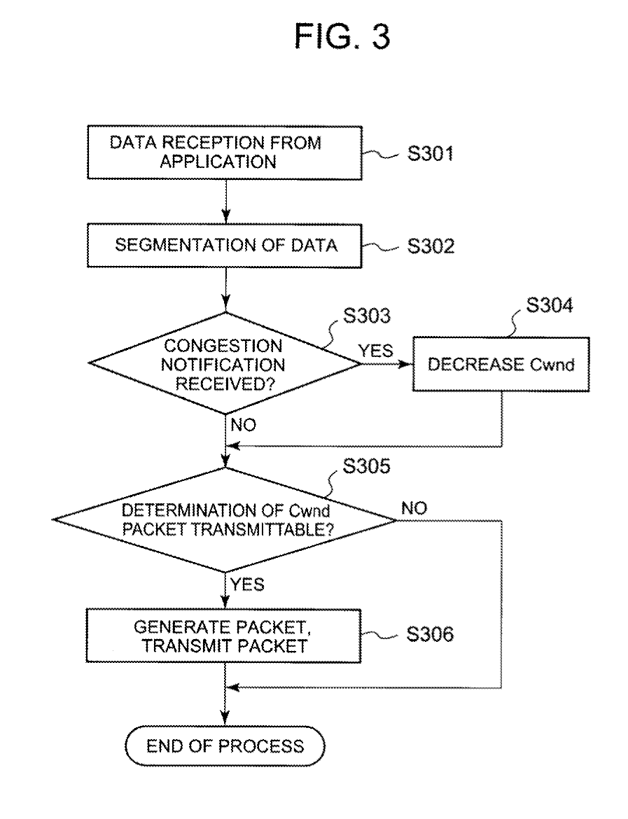

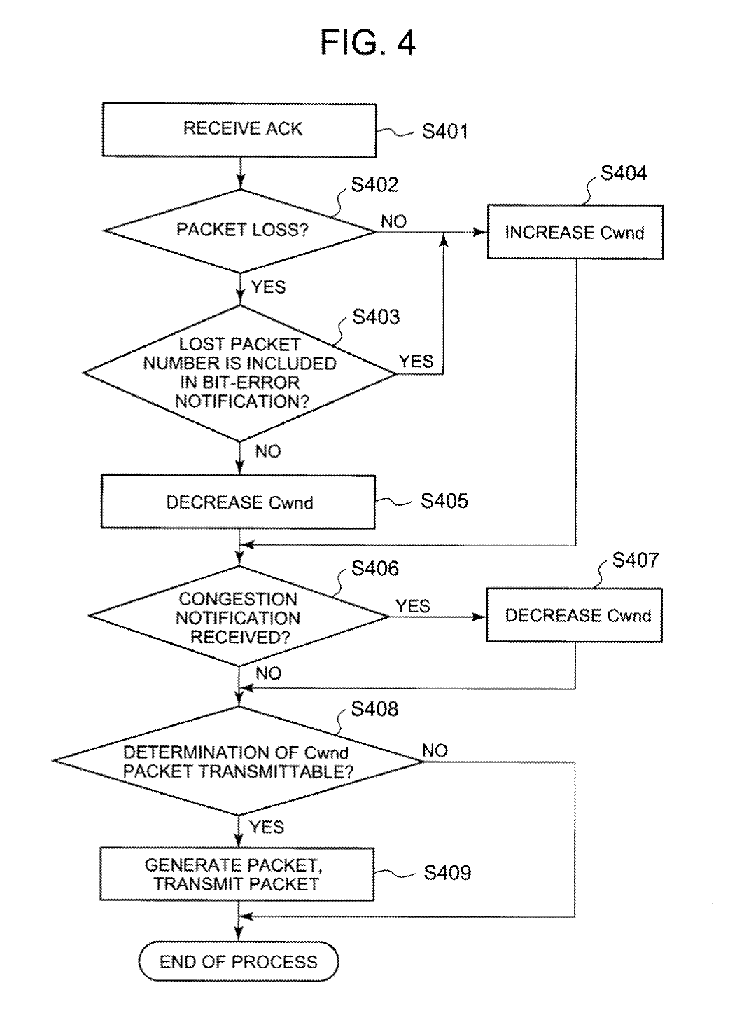

Next will be described an operation of the TCP processing section 113 with reference to flowcharts of FIG. 3 and FIG. 4.

In a case where the TCP processing section 113 receives data from the application 112, and in a case where the TCP processing section 113 receives an ACK packet from the IP processing section 114, the TCP processing section 113 starts its process. Note that a timer is set as long as there are segments waiting for transmission, and every time the timer is activated, a transmission process is performed similarly to the case where the TCP processing section 113 receives data from the application 112.

As shown in FIG. 3, when the TCP processing section 113 receives data from the application 112 (Step S301), the data transmission part 1132 of the TCP processing section 113 divides the data into segments by a preset size, assigns serial numbers to the segments, and then stores the segments in the segment storage part 1133 (Step S302).

Then, the congestion-window determining part 1131 compares a present time with a time at which a congestion notification was received previously. If the congestion notification was received within a setting time (at a past point of time within the setting time back from the present time), the process of the TCP processing section 113 proceeds to Step S304. If the congestion notification was received not within the setting time, the process proceeds to Step S305.

In Step S304, the congestion-window determining part 1131 decreases a congestion window (that is, the congestion window is set to “Cwnd=Cwnd÷A”). In the present exemplary embodiment, A is set to 2. Note however that A may be set to be smaller than 2 (i.e., A<2), or may be determined in accordance with a given calculating formula. Then, the process proceeds to Step S305.

In Step S305, the congestion-window determining part 1131 refers to the congestion window (Cwnd), serial numbers (UnAcked) of packets that have been transmitted, and serial numbers (Acked) of acknowledgement packets. If the number of packets that have been transmitted but have not been acknowledged yet is Larger than the congestion window (Cwnd>UnAcked−Acked), the congestion-window determining part 1131 determines that a packet is transmittable, and the process proceeds to Step S306. If not (Cwnd≦UnAcked−Acked), the process is terminated.

In Step S306, the data transmission part 1132 takes out, from the segment storage part 1133, segments of serial numbers to be subsequently transmitted (from UnAcked+1 to Cwnd), generates packets of the segments, and then outputs the packets thus generated to the IP processing section 114. Thus, the process is completed. If an error notification is returned from the IP processing section 114, which error notification indicates that any further packet is not receivable because the packet storage section 116 is full, the data transmission part 1132 temporarily stops the output of packets, and after a while, retries to output the packets.

As shown in FIG. 4, in a case where the TCP processing section 113 receives an ACK packet of TCP from the IP processing section 114 (Step S401), the data transmission part 1132 determines whether packet loss has occurred or not. If the data transmission part 1132 determines that packet loss has occurred, the data transmission part 1132 memorizes a packet number (Lost) of a lost packet. Subsequently, the data transmission part 1132 retransmits the lost packet to the receiver. After that, the process of the TCP processing section 113 proceeds to Step S403. In a case where the TCP processing section 113 determines that no packet loss has occurred, the process proceeds to Step S404. How to determine whether packet loss has occurred or not may be performed by a method using a SACK option, a method for detecting sequential reception of ACK packets having the same number, or the like method.

In Step S403, the congestion-window determining part 1131 checks whether the packet number (Lost) of the lost packet is included in a packet number set (Errored) of which an error notification has been received. If the packet number (Lost) of the lost packet is included in the packet number set, the congestion-window determining part 1131 determines that the packet was lost due to a factor other than congestion, and the process proceeds to Step S404.

In Step S404, the congestion-window determining part 1131 increases the congestion window. For example, the congestion window is set to (Cwnd=Cwnd+1/RTT). The congestion window may be set to Cwnd=Cwnd+β (β is a given setting value). Then, the process proceeds to Step S406.

If the packet number (Lost) of the lost packet is not included in the packet number set, the congestion-window determining part 1131 decreases the congestion window (Step S405). For example, the congestion window is set to (Cwnd=Cwnd/2). Then, the process proceeds to Step S406.

In Step S406, the congestion-window determining part 1131 compares a present time with a time at which a congestion notification was received previously. If the congestion notification was received within a setting time (at a past point of time within the setting time back from the present time), the congestion-window determining part 1131 determines that congestion occurs in a network, and the process proceeds to Step S407. If the congestion notification was received not within the setting time, the process proceeds to Step S408.

In Step S407, the congestion-window determining part 1131 decreases the congestion window. For example, the congestion window is set to (Cwnd=Cwnd−1). The process then proceeds to Step S408.

In Step S408, the data transmission part 1132 refers to the congestion window and determines whether or not packets are further transmittable to the receiver. For example, in a case of Cwnd>Unacked, the data transmission part 1132 determines that the number of transmittable packets is (Cwnd−Unacked). When the data transmission part 1132 determines that it is possible to further transmit packets to the receiver, the process proceeds to Step S409. When the data transmission part 1132 determines that no further packet is transmittable, the process is terminated.

In Step S409, the data transmission part 1132 takes out segments from the segment storage part 1133, generates packets of the segments, and outputs the packets thus generated to the IP processing section 114. Thus, the process is completed. Note however that if an error notification is returned from the IP processing section 114, which error notification indicates that any further packet is not receivable because the packet storage section 116 is full, the data transmission part 1132 temporarily stops the output of packets, and after a while, retries to output the packets.

There are various options in TCP other than the above example. Further, the transmission rate control method of the present exemplary embodiment can be applied not only to a protocol like TCP that performs a window control, but also to general communication in which transmission rates are accommodated between terminals.

In the present exemplary embodiment, the receiver may be any terminal as long as it can perform a receiving operation by general TCP. When the receiver receives a segment from the transmitter, the receiver sends back an ACK packet, i.e., an acknowledgement, to the transmitter. If packet loss has occurred, the receiver notifies the transmitter that packet loss has occurred, by sending a duplicate ACK or a SACK.

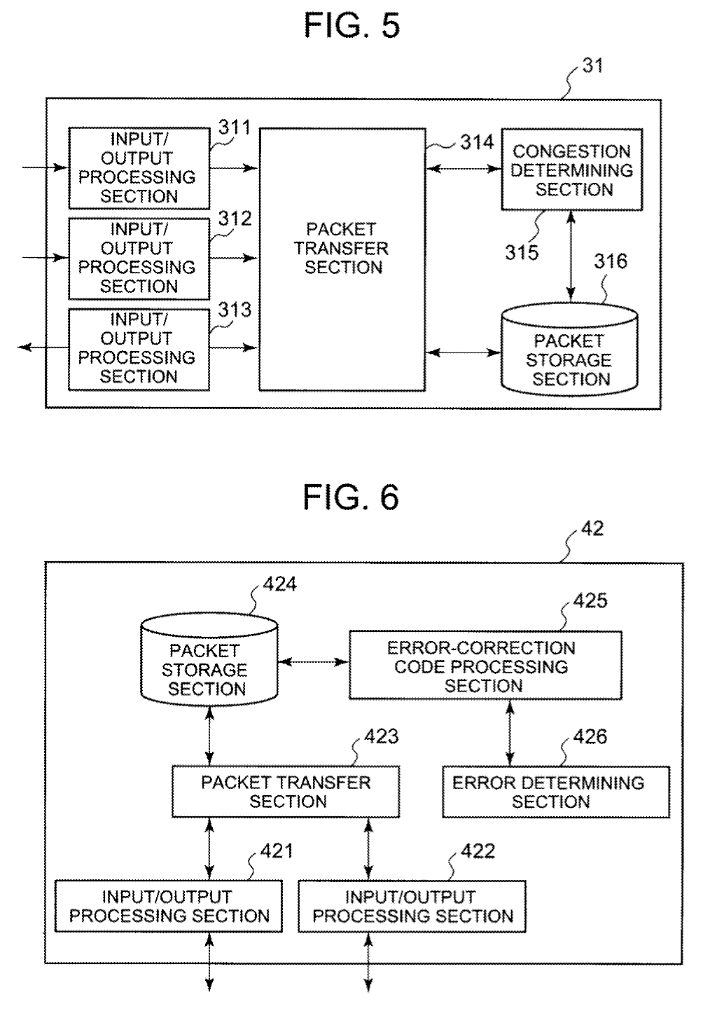

FIG. 5 is a block diagram showing an example of an arrangement of the switch 31 shown in FIG. 1. In the example shown in FIG. 5, an input/output processing section 311 receives packets from the transmitter 11. An input/output processing section 312 receives packets from the transmitter 12. An input/output processing section 313 transmits a packet to the transmitter 11, 12. In FIG. 5, only one input/output processing section 313 is shown as a typical example. A packet transfer section 314 stores, in a packet storage section 316, a packet received by each of the input/output processing sections 311 and 312. In the meantime, the packet transfer section 314 determines to which input/output processing section 313 a packet should be transmitted, by referring to a packet header, and outputs the packet to a corresponding input/output processing section 313. If the corresponding input/output processing section 313 is still being transmitting packets, the packet transfer section 314 retries to output the packet after a predetermined setting time.

Further, in a case where the packet transfer section 314 receives a congestion notification from a congestion determining section 315, when the packet transfer section 314 receives a new packet from the input/output processing section 311 or 312, the packet transfer section 314 transmits a congestion notification to a source of the packet thus received. The congestion determining section 315 observes an occupancy rate of the packet storage section 316. If the packet storage section 316 is full or almost full (for example, 90%), that is, the occupancy rate is a setting value or more, the congestion determining section 315 continuously outputs the congestion notification to the packet transfer section 314. When the occupancy rate of the packet storage section 316 decreases to the setting value or below, the congestion determining section 315 stops sending the congestion notification to the packet transfer section 314.

FIG. 6 is a block diagram showing an example of an arrangement of the line terminating equipment 42 shown in FIG. 1. In the example of FIG. 6, input/output processing sections 421 and 422 receive a packet to which an error-correction code is assigned in the line terminating equipment 41. A packet transfer section 423 stores a received packet in a packet storage section 424. The packet thus stored in the packet storage section 424 is decoded by an error-correction code processing section 425. If the packet thus stored contains a slight bit error, the error-correction code processing section 425 recovers the bit error. If the packet thus stored contains a significant bit error and only a part of the packet is restored, the error-correction code processing section 425 sends the part of the packet to an error determining section 426.

If the error determining section 426 can read a source address of the packet and a serial number of the packet, the error determining section 426 transmits to the source address an error notification in which the serial number of the packet is stored. If a packet that has been decoded remains in the packet storage section 424, the packet transfer section 423 outputs the packet to an input/output processing section in an output direction.

The arrangement of the line terminating equipment 41 shown in FIG. 1 is the same as the arrangement of the line terminating equipment 42 shown in FIG. 5. However, in the line terminating equipment 41, an error-correction code processing section adds an error-correction code to a packet received by an input/output processing section.

In accordance with the aforementioned processes, the transmitters 11 and 12 can quickly detect congestion and bit error in a communication line, so that the transmitters 11 and 12 can appropriately adjust the transmission rate in accord with the congestion and bit error.

That is, in the present exemplary embodiment, the transmitter causes a communication unit (the switch 31 in the above example) in the network to transmit information indicative of a congestion state, so that the transmitter determines whether packet loss has occurred or not, by referring to the information indicative of the congestion state. Further, the transmitter collects information on transmission error from a communication unit (the line terminating equipment 42 in the above example) in the network, so that the transmitter figures out packet loss caused due to factors other than congestion, by referring to the information on the transmission error. This accordingly allows the transmitter to accurately figure out what caused packet loss and what caused an increase in delay. Consequently, it is possible to perform a suitable transmission rate control adequately in accordance with the congestion state.

Further, in a case where the transmitter causes a communication unit (the switch 31 in the above example) in the network to transmit information indicative of a sign of congestion, the transmitter determines whether or not packet loss occurs, by referring to the information indicative of the sign of congestion. Further, the transmitter collects information on transmission error from a communication unit (the line terminating equipment 42 in the above example) in the network, so that the transmitter figures out packet loss caused due to factors other than congestion, by referring to the information on the transmission error. This accordingly allows the transmitter to accurately figure out what causes packet loss and what caused an increase in delay. Consequently, it is possible to perform a suitable transmission rate control adequately in accordance with the congestion state.

Moreover, it is possible to quickly increase a rate of TCP by grasping the state of transmission error or the congestion state in the network, or both of the state of transmission error and the congestion state.

### Exemplary Embodiment 2

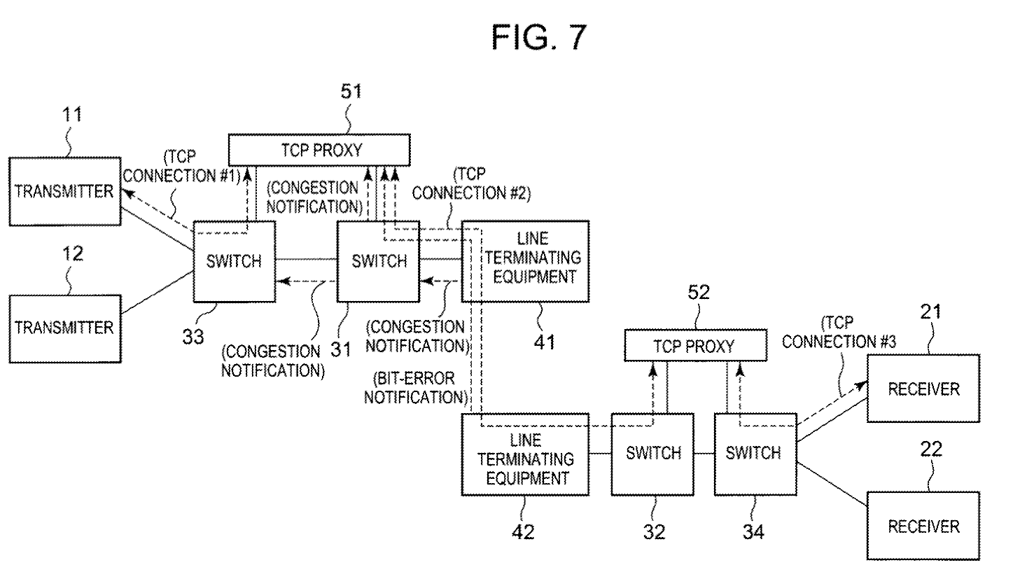

FIG. 7 is a block diagram showing Exemplary Embodiment 2 of the communication system according to the present invention. In Exemplary Embodiment 2, a switch (third switch) 33, TCP proxies 51 and 52, a switch (fourth switch) 34 are provided in addition to the arrangement of the communication system according to Exemplary Embodiment 1. Further, in Exemplary Embodiment 2, it is assumed that the transmission rate control method is used in TCP communication between the TCP proxy 51 and the TCP proxy 52 each serving as a transmission unit.

A TCP proxy is an unit for transferring data received from a transmitter, by use of a new TCP connection. In the example shown in FIG. 7, data is transferred between a transmitter 11 and the TCP proxy 51 by use of a TCP connection #1. The TCP proxy 51 that has received the data via the TCP connection #1 transfers the data to the TCP proxy 52 by use of a TCP connection #2 that employs the transmission rate control method according to the present invention. The data received by the TCP proxy 52 is transferred to a receiver 21 via a TCP connection #3.

In Exemplary Embodiment 2, communication that employs the transmission rate control method according to the present invention is performed between the TCP proxies. Communication between each terminal and a corresponding TCP proxy is performed by using general TCP. Such an arrangement allows various terminals to use the transmission rate control method according to the present invention as a part of their communication paths. As a communication path between a switch and a terminal, a line such as the Internet may be used.

A presumable example is such that Exemplary Embodiment 2 is applied to marine communication in which a line delay is large between pieces of line terminating equipment and bit error may occur. In such a line in which a large delay occurs, it is notable that the performance of the TCP communication is not brought out. In the present exemplary embodiment, the TCP proxies 51 and 52 are provided in vicinal areas (for example, in a LAN via a switch) of respective pieces of line terminating equipment provided at respective ends of the line. By using the TCP proxies 51 and 52 as such, it is possible to improve use efficiency of the line as described below. Note that, in the following explanation, it is assumed that packet loss due to bit error occurs only in a communication network between the pieces of line terminating equipment 41 and 42, and no packet loss due to bit error occurs in any other communication paths.

In the communication system shown in FIG. 7, a pause signal or a back-pressure signal of a link-layer flow control is used in communication between the switch 31 and the TCP proxy 51 so as to prevent packet loss between the switch 31 and the TCP proxy 51. This causes packets to accumulate, in a transmission buffer of an IP layer of the TCP proxy 51. However, in the present exemplary embodiment, when the buffer of the IP layer becomes full, a TCP processing section 113 temporarily stops transmission by TCP until the buffer of the IP layer becomes available. Similarly, the pause signal or back-pressure signal of a link-layer flow control is used in communication between the line terminating equipment 41 and the switch 31 so as to prevent that a packet from the switch 31 is lost.

In a case where the link-layer flow control cannot be used in all lines connecting from the TCP proxy 51 to the line terminating equipment 41, a line bandwidth available between the pieces of line terminating equipment 41 and 42 is calculated in the following manner.

That is, between the pieces of line terminating equipment 41 and 42, an error-correction code is added to a packet, thereby increasing a data amount of the packet. In view of this, an actually-available bandwidth between the pieces of line terminating equipment 41 and 42 is reduced by an overhead due to an increased data amount. An example of the method using an error-correction code is a method for dynamically changing intensity of a code depending on an error rate. On this account, an available equivalent bandwidth is changed. In view of this, the line terminating equipment 41 transmits an error notification that contains information on the equivalent bandwidth, to the TCP proxy 51. The TCP proxy 51 regards the equivalent bandwidth thus notified as a maximum transmission rate, and controls the transmission rate based on the maximum transmission rate. The equivalent bandwidth may be notified separately from the error notification.

As such, the TCP proxy 51 does not increase the transmission rate over the equivalent bandwidth available between the pieces of line terminating equipment 41 and 42, thereby resulting in that a packet buffer in the line terminating equipment 41 does not overflow unless a line from the switch 33 to the switch 31 is used. Further, a priority queue control may be introduced in the line terminating equipment 41 such that packets via the TCP proxy 51 are set to high priority, thereby preventing an occurrence of packet loss.

By performing the aforementioned control, it is possible to prevent that packets transmitted from the TCP proxy 51 are lost in the lines connected from the TCP proxy 51 to the line terminating equipment 42.

Further, in a case where the arrangement shown in FIG. 7 is employed, when a line from the switch 32 to the TCP proxy 52 is a higher-speed line than or the same-speed line as a line from the line terminating equipment 42 to the switch 32, different streams of communication traffic in the same direction are never joined together. As a result, no congestion occurs, thereby causing no packet loss. Further, it is also possible to use a link-layer flow control or the like. Note that the link-layer flow control is not passed on between the pieces of line terminating equipment 41 and 42.

In this way, it is possible to limit factors of packet loss occurring in the communication from the TCP proxy 51 to the TCP proxy 52, to error occurring between the pieces of line terminating equipment 41 and 42. As a result, if packet loss on a TCP level is detected at the TCP proxy 52, it is possible to specify that the packet loss has occurred due to error between the pieces of line terminating equipment 41 and 42.

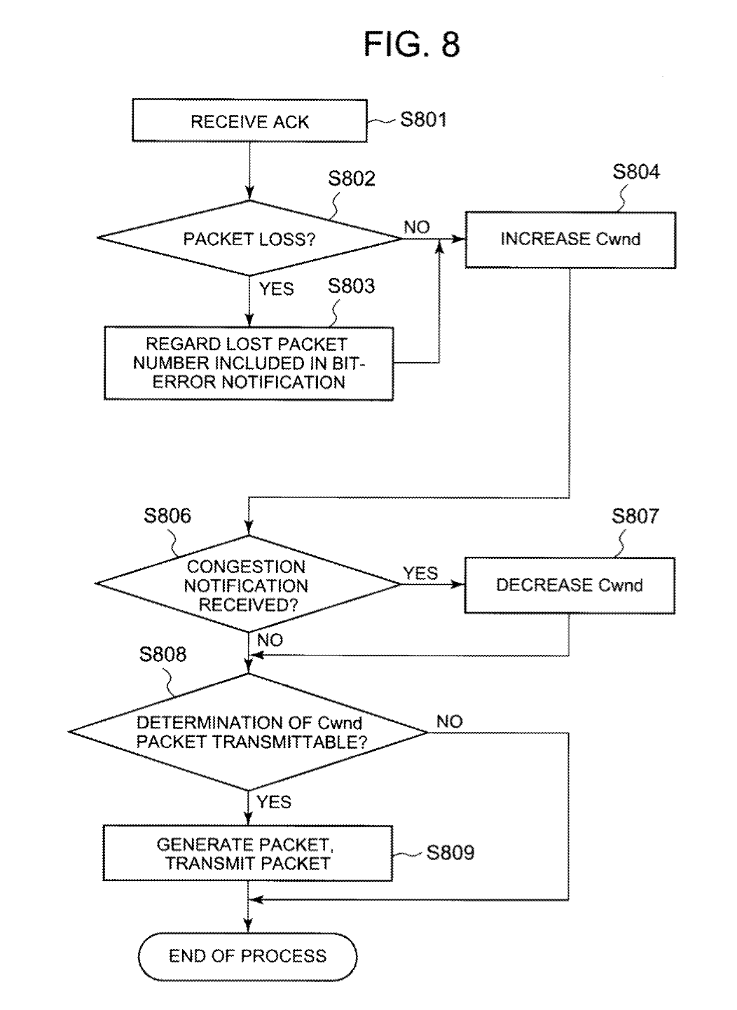

Further, in the present exemplary embodiment, as shown in FIG. 8, a TCP transmitting side performs a different operation from the operation in Exemplary Embodiment 1, when receiving an ACK. More specifically, as shown in FIG. 8, in Step S803, when the TCP transmitting side detects packet loss, it regards that the packet loss has occurred due to bit error. Note that in Step S807, traffic transmitted from the TCP proxy may be regarded as high priority, and the congestion window may not be decreased. Other steps are the same as those in FIG. 4.

As such, in the present exemplary embodiment, factors that cause packet loss can be limited to bit error occurring between the pieces of line terminating equipment 41 and 42. Accordingly, from a viewpoint of the TCP proxy 51 that performs TCP communication, the transmission rate is controlled by a link-layer flow control that is transmitted from the line terminating equipment 41 or the switch 31 provided before the line terminating equipment 41.

As a result, in the TCP transmitting process of the TCP proxy 51, it is possible to quickly detect a sign of congestion and quickly increase the transmission rate. Further it is also possible to set a default value of the congestion window to a sufficiently large value, for example, 1000 packets or the like, whereas the default value is generally 1 to 4 packets. Consequently, high communication performance can be exercised.

Further, unless packet loss that cannot be specified by a bit-error notification between the TCP proxies 51 and 52 occurs, for example, it is possible to perform a transmission rate control so that data is transmitted from the TCP proxy 51 to the TCP proxy 52 at a rate equivalent to a transmission rate from the transmitter 11 to the TCP proxy 51.

In a case where communication is temporarily stopped in response to a congestion notification, if communication using TCP is performed via a line in which a delay occurs, communication efficiency decreases significantly. That is, the use of a link-layer control such as the flow control is actually limited to a network in which a delay is sufficiently small. As such, it is difficult to use the link-layer control for TCP/IP communication or the like in a line in which a large delay occurs. However, in the arrangement of Exemplary Embodiment 2, TCP by which data is transferred from the transmitter is once terminated at a TCP proxy. Then, the data is transferred to another TCP proxy by use of another TCP connection, followed by terminating TCP of the another TCP connection. Ultimately, the data is transferred to the receiver by use of a new TCP connection.

With such an arrangement, in communication including lines that causes a decrease in performance in TCP/IP communication, such as a line in which bit error occurs, a line in which a communication bandwidth is changed, and the like lines, it is possible to eliminate packet loss caused due to congestion in a network from a TCP proxy that controls a transmission rate for TCP to line terminating equipment. Furthermore, the above arrangement also makes it possible to eliminate packet loss caused due to congestion in a network from the line terminating equipment to a TCP proxy of a receiving side. As a result, only error occurring between pieces of line terminating equipment may have to be taken account of in connection with the TCP transmission rate control. Consequently, it is possible to achieve high communication performance as compared with a conventional communication system.

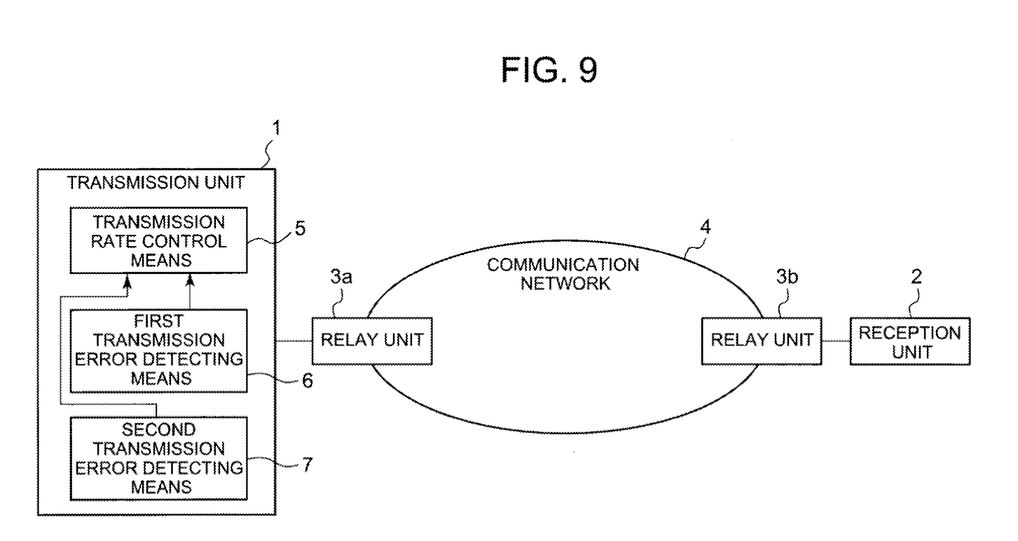

FIG. 9 is a block diagram showing an essential part of a communication system in which the transmission rate control method according to the present invention is performed. As shown in FIG. 9, the communication system is a communication system in which a transmission unit 1 transmits data to a reception unit 2 via relay units 3a and 3b, and a communication network 4. In the communication system, the transmission unit 1 includes transmission rate control means 5 for controlling a transmission rate, first transmission error detecting means 6 for detecting that data loss occurs due to congestion in the communication network, and second transmission error detecting means 7 for detecting that data loss (for example, packet loss) has occurred due to data error in the communication network. The transmission rate control means 5 performs different transmission rate controls, respectively, to a case where the first transmission error detecting means 6 has detected that data loss occurs and to a case where the second transmission error detecting means 7 has detected that data loss has occurred due to data error.

Further, the aforementioned exemplary embodiments also disclose the following transmission rate control methods.

(1) The transmission rate control method in which an occupancy rate of a data buffer (for example, the packet storage section 316) of a relay unit (for example, the switch 31) that relays data is used in detecting data loss caused due to congestion.

(2) The transmission rate control method in which the transmission rate is changed in accordance with the occupancy rate of the data buffer (for example, when the packet storage section 316 is full or almost full (the occupancy rate is 90%, for example), the transmission rate is decreased), and the transmission rate is changed in accordance with an occurrence state of data error (for example, the transmission rate is changed depending on a determination result of whether or not packet loss occurs).

(3) The transmission rate control method in which the transmission rate is changed in accordance with the occupancy rate of the data buffer, and the transmission rate is maintained regardless of an occurrence state of data error (for example, even if an occurrence of packet loss is detected, the transmission rate is not changed).

(4) The transmission rate control method including retransmitting the data immediately when data loss having been caused duo to data error has been detected.

(5) The transmission rate control method including retransmitting the data regardless of a degree of the congestion, when data loss having been caused due to data error has been detected.

(6) The transmission rate control method in which data loss caused due to congestion is detected based on an occupancy rate of a data buffer in a part (for example, a communication link between the transmitter 11 and the switch 31) of a communication path, and an occurrence state of data error in another part (for example, a communication link between the switch 31 and the line terminating equipment 42) of the communication path is detected.

(7) The transmission rate control method in which a congestion notification transmitted from a relay unit (for example, the switch 31) provided in the part of the communication path is used in detecting data loss caused due to congestion.

(8) The transmission rate control method in which a pause signal or a back-pressure signal for temporarily stopping communication, which pause signal or back-pressure signal is transmitted from a relay unit (for example, the switch 31) provided in the part of the communication path, is used in detecting data loss caused due to congestion.

(9) The transmission rate control method in which an acknowledgement signal (for example, an ACK in TCP or a protocol similar to the TCP) in a transport layer is used in detecting the occurrence state of data error.

(10) The transmission rate control method in which an error notification transmitted from transmission equipment (for example, the line terminating equipment 42) provided in the communication path is used in detecting the occurrence state of data error.

(11) The transmission rate control method in which a notification of an error rate transmitted from transmission equipment (for example, the line terminating equipment 42) provided in the communication path is used in detecting the occurrence state of data error.

(12) The transmission rate control method in which the transmission rate is adjusted to a maximum value (for example, a transmission rate corresponding to an equivalent bandwidth (B(1−ρ)) of the transmission rate calculated based on the error rate.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2009-54004, filed on Mar. 6, 2009, the disclosure of which is incorporated herein in its entirety by reference.

### REFERENCE SIGNS LIST

1 Transmission Unit

2 Reception Unit

3a, 3b Relay Unit

4 Communication Network

5 Transmission rate Control Means

6 First Communication Error Detecting Means

7 Second Communication Error Detecting Means

11, 12 Transmitter

21, 22 Receiver

31, 32, 33, 34 Switch

41, 42 Line terminating Equipment

51, 52 TCP proxy

111 Data Storage Section

112 Application

113 TCP Processing Section

114 IP Processing Section

115 Input/output Processing Section

116 Packet Storage Section

311 to 313 Input/output Processing Section

314 Packet Transfer Section

315 Congestion Determining Section

316 Packet Storage Section

421, 422 Input/output Processing Section

423 Packet Transfer Section

424 Packet Storage Section

425 Error-correction Coding Processing Section

426 Error Determining Section

1131 Congestion-window Determining Part

1132 Data Transmission Part

1133 Segment Storage Part

1134 Congestion Notification Receiving Part

1135 Error Notification Receiving Part

1-18. (canceled)

19. A transmission rate control method for controlling a transmission rate by a transmission unit that transmits data to a reception unit via a communication network, the transmission rate control method comprising:
detecting data loss caused due to congestion in the communication network;
detecting data loss caused due to data error in the communication network; and
applying different transmission rate controls, respectively, to a case where data loss is caused due to congestion and to a case where data loss is caused due to data error.

20. The transmission rate control method according to claim 19, wherein:
an occupancy rate of a data buffer of a relay unit that relays the data is used in detecting data loss caused due to congestion.

21. The transmission rate control method according to claim 20, wherein:
the transmission rate is changed in accordance with the occupancy rate of the data buffer; and
the transmission rate is controlled in accordance with an occurrence state of data error.

22. The transmission rate control method according to claim 20, wherein:
the transmission rate is changed in accordance with the occupancy rate of the data buffer; and
the transmission rate is maintained regardless of an occurrence state of data error.

23. The transmission rate control method according to claim 22, comprising:
retransmitting the data immediately when data loss caused due to data error has been detected.

24. The transmission rate control method according to claim 22, comprising:
retransmitting the data regardless of a degree of the congestion, when data loss caused due to data error has been detected.

25. The transmission rate control method according to claim 21, wherein:
data loss caused due to congestion is detected based on an occupancy rate of a data buffer in a part of a communication path; and
an occurrence state of data error in another part of the communication path is detected.

26. The transmission rate control method according to claim 25, wherein:
a congestion notification transmitted from a relay unit provided in the part of the communication path is used in detecting data loss caused due to congestion.

27. The transmission rate control method according to claim 25, wherein:
a pause signal or a back-pressure signal for temporarily stopping communication, which pause signal or back-pressure signal is transmitted from a relay unit provided in the part of the communication path, is used in detecting data loss caused due to congestion.

28. The transmission rate control method according to claim 25, wherein:
an acknowledgement signal in a transport layer is used in detecting the occurrence state of data error.

29. The transmission rate control method according to claim 25, wherein:
an error notification transmitted from transmission equipment provided in the communication path is used in detecting the occurrence state of data error.

30. The transmission rate control method according to claim 25, wherein:
a notification of an error rate transmitted from transmission equipment provided in the communication path is used in detecting the occurrence state of data error.

31. The transmission rate control method according to claim 30, wherein:
the transmission rate is adjusted to a maximum value of the transmission rate calculated based on the error rate.

32. A transmission unit for transmitting data to a reception unit via a communication network, the transmission unit comprising:
transmission rate control unit which controls a transmission rate;
first transmission error detecting unit which detects data loss caused due to congestion in the communication network; and
second transmission error detecting unit which detects data loss caused due to data error in the communication network,
wherein:
the transmission rate control unit controls the transmission rate separately for a case where the first transmission error detecting unit has detected data loss and a case where the second transmission error detecting unit has detected data loss caused due to data error.

33. The transmission unit according to claim 32, wherein:
the first transmission error detecting unit uses an occupancy rate of a data buffer of a relay unit that relays the data, so as to detect data loss caused due to congestion.

34. A communication system in which a transmission unit transmits data to a reception unit via a relay unit and a communication network,
the transmission unit including:
transmission rate control unit which controls a transmission rate;
first transmission error detecting unit which detects data loss caused due to congestion in the communication network; and
second transmission error detecting unit which detects data loss caused due to data error in the communication network,
wherein:
the transmission rate control unit controls the transmission rate separately for a case where the first transmission error detecting unit has detected data loss and a case where the second transmission error detecting unit has detected data loss caused due to data error.

35. The communication system according to claim 34, wherein:
the first transmission error detecting unit of the transmission unit uses an occupancy rate of a data buffer of the relay unit that relays the data, so as to detect data loss caused due to congestion.

36. The communication system according to claim 35, wherein:
the relay unit sends a congestion notification to the transmission unit when the data buffer is full or when the occupancy rate exceeds a predetermined value.

37. A transmission unit for transmitting data to a reception unit via a communication network, the transmission unit comprising:
transmission rate control means for controlling a transmission rate;
first transmission error detecting means for detecting data loss caused due to congestion in the communication network; and
second transmission error detecting means for detecting data loss caused due to data error in the communication network,
wherein:
the transmission rate control means controls the transmission rate separately for a case where the first transmission error detecting means has detected data loss and a case where the second transmission error detecting means has detected data loss caused due to data error.

38. A communication system in which a transmission unit transmits data to a reception unit via a relay unit and a communication network,
the transmission unit including:
transmission rate control means for controlling a transmission rate;
first transmission error detecting means for detecting data loss caused due to congestion in the communication network; and
second transmission error detecting means for detecting data loss caused due to data error in the communication network,
wherein:
the transmission rate control means controls the transmission rate separately for a case where the first transmission error detecting means has detected data loss and a case where the second transmission error detecting means has detected data loss caused due to data error.
